(19) United States
(12) Patent Application Publication
(10) Pub. No.: US 2013/0069841 A1
(43) Pub. Date: Mar. 21, 2013

(54) ANTENNA APPARATUS FOR A PORTABLE TERMINAL

(71) Applicants: Seung-Jun Lee, Seongnam-si (KR); Sung-Won Park, Suwon-si (KR); Jae-Sun Park, Suwon-si (KR); Jae-Min Seo, Suwon-si (KR)

(72) Inventors: Seung-Jun Lee, Seongnam-si (KR); Sung-Won Park, Suwon-si (KR); Jae-Sun Park, Suwon-si (KR); Jae-Min Seo, Suwon-si (KR)

(73) Assignee: SAMSUNG ELECTRONICS CO., LTD., Suwon-si (KR)

(21) Appl. No.: 13/619,150

(22) Filed: Sep. 14, 2012

(30) Foreign Application Priority Data
Sep. 20, 2011 (KR) 10-2011-0094633

(51) Int. Cl. H01Q 21/00

(52) U.S. Cl. 343/846; 343/893

(57) ABSTRACT

According to one embodiment, an antenna apparatus for a portable terminal includes a main board, a first antenna and a second antenna electrically coupled to the main board and spaced apart from each other on the main board, and a ground body protruding from a top surface or a bottom surface of the main board.

### CROSS-REFERENCE TO RELATED APPLICATION AND CLAIM OF PRIORITY

The present application is related to and claims priority under 35 U.S.C. §119 to an application filed in the Korean Intellectual Property Office on Sep. 20, 2011 and assigned Serial No. 10-2011-0094633, the contents of which are incorporated herein by reference.

### TECHNICAL FIELD OF THE INVENTION

The present invention generally relates to antenna structures, and more particularly, to an antenna apparatus for a portable terminal.

### BACKGROUND OF THE INVENTION

Portable terminals have become widely used in modern society and have become important means of transmitting rapidly-changing information. In order to attract more users, portable terminals are being developed with more convenient functions.

Communication networks, such as GSM, PCS, DMB, WLAN, WiBro, LTEWiMax, and 802.11n, have been implemented, and portable terminals capable of using these communication networks, without being limited to one particular communication network, are also increasing.

In order to transmit and receive signals using multiple communication service bands, portable terminals can be configured with multiple antennas. Moreover, in order to transmit and receive signals of relevant communication service bands, portable terminals can be configured with multiple antennas. However, if multiple antennas are provided given the limited space provided by typical portable terminals, the performance of the antennas can be degraded due to interference between antennas. FIG. 1 illustrates a conventional antenna apparatus. Referring to FIG. 1, the conventional antenna apparatus 100 includes a main board 110 configured to process a signal, and a first antenna 120 and a second antenna 130 configured to communicate with the main board 110 and transmit and receive radio signals. In general, if antennas are located close to each other, the antennas can interfere with each other. Therefore, the two antennas 120 and 130 are sufficiently spaced apart from each other. As illustrated, in a case where the two antennas 120 and 130 need to be inevitably located close to each other, the two antennas 120 and 130 interfere with each other such that it can be difficult to ensure the sufficient performance thereof.

### SUMMARY OF THE INVENTION

To address the above-discussed deficiencies of the prior art, it is a primary object to provide at least the advantages below. Accordingly, an object of the present disclosure is to provide an antenna apparatus for a portable terminal, which reduces mutual interference, without spacing antennas apart from each other.

Another object of the present disclosure is to provide an antenna apparatus for a portable terminal, which improves isolation between adjacent antennas.

In accordance with an aspect of the present disclosure, an antenna apparatus for a portable terminal includes a main board, a first antenna and a second antenna electrically coupled to the main board and spaced apart from each other on the main board, and a ground body protruding from a top surface or a bottom surface of the main board.

Other aspects, advantages and salient features of the disclosure will become apparent to those skilled in the art from the following detailed description, which, taken in conjunction with the annexed drawings, discloses exemplary embodiments of the disclosure.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example conventional antenna apparatus;

FIG. 2 illustrates an example portable terminal according to an embodiment of the present disclosure;

FIGS. 3 and 4 illustrate example perspective views of an antenna apparatus according to an embodiment of the present disclosure;

FIGS. 5A to 5C illustrate example schematic views of an antenna apparatus according to an embodiment of the present disclosure;

FIGS. 6 and 7 illustrate example perspective views of antenna apparatuses according to embodiments of the present disclosure;

FIG. 8A illustrates example graphs for isolation (S21) of the conventional antenna apparatus; and

FIG. 8B illustrates an example graph showing isolation of the antenna apparatus according to the embodiment of the present disclosure.

Throughout the drawings, like reference numerals will be understood to refer to like parts, components and structures.

### DETAILED DESCRIPTION OF THE INVENTION

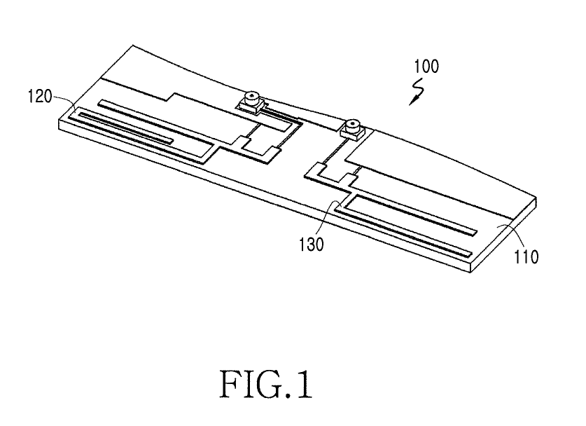

FIGS. 1 through 8B, discussed below, and the various embodiments used to describe the principles of the present disclosure in this patent document are by way of illustration only and should not be construed in any way to limit the scope of the disclosure. Those skilled in the art will understand that the principles of the present disclosure can be implemented in any suitably arranged communications system. Exemplary embodiments of the present disclosure will be described herein below with reference to the accompanying drawings. In the following description, detailed descriptions of well-known functions or configurations will be omitted since they would unnecessarily obscure the subject matters of the present disclosure. Also, the terms used herein are defined according to the functions of the present disclosure. Thus, the terms can vary depending on users' or operators' intentions or practices. Therefore, the teens used herein must be understood based on the descriptions made herein.

The present disclosure relates to an antenna apparatus for a portable terminal, which is capable of improving isolation between antennas. An antenna apparatus according to an embodiment of the present disclosure smoothly transmits or receives signals of relevant communication service bands without degradation of performance, even though antennas are not spaced apart from each other.

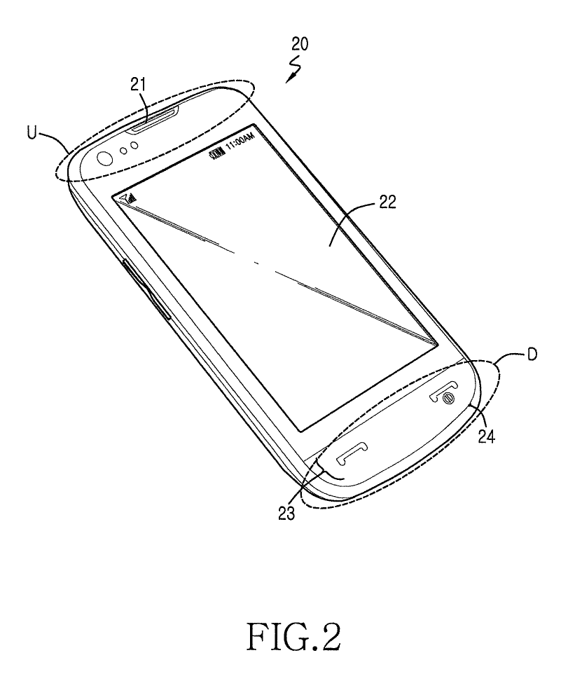

FIG. 2 illustrates an example portable terminal according, to an embodiment of the present disclosure.

Referring to FIG. 2, the portable terminal 20 includes a speaker 21 configured to output an electric signal in audible form, a display 22 configured to output an image, a microphone 24 configured to convert a sound into an electric signal, and an input button 23. The display 22 can be any suitable type, such as a Liquid Crystal Display (LCD) or a touch screen with a touch panel attached to the LCD.

The portable terminal 20 includes an antenna apparatus configured to perform radio communication and has the following structure. An antenna apparatus according to an embodiment of the present disclosure includes multiple antennas configured to transmit and receive signals of relevant communication service bands, and a main board configured to process signals that are transmitted or received through the antennas. The antennas are disposed at either an upper portion U or a lower portion D of the portable terminal 20. Since a user usually holds the portable terminal at its side, certain embodiments can benefit by placement of the antennas at either the upper portion U or the lower portion D. In other embodiments, the antennas can be disposed at any suitable location of the portable terminal 20.

In particular, even though the antennas are located close to each other, the antenna apparatus according to the embodiment of the present disclosure can improve isolation between the antennas and thus ensure the performance thereof. To this end, the antenna apparatus according to the embodiment of the present disclosure achieves the intended purpose by configuring a ground body protruding from the top or bottom surface of the main board. The ground body is electrically coupled to a ground layer of the main board and serves to block harmful components such as noise. The ground body is electromagnetically coupled to the antennas and can remove harmful signals caused by mutual interference between the antennas, leading to an improvement of isolation.

The ground layer of the main board can be provided on the top surface or bottom surface of the main board or inside the main board, and can be integrated by electrical connection though lines or vias.

Each antenna of the antenna apparatus can be configured to transmit and receive signals of different communication service bands, but is not limited thereto. Each antenna of the apparatus can also be configured to transmit or receive signals of the same communication service band. In this case, the antenna apparatus according to the embodiment of the present disclosure can operate as a known diversity antenna apparatus or multiple input multiple output (MIMO) antenna apparatus.

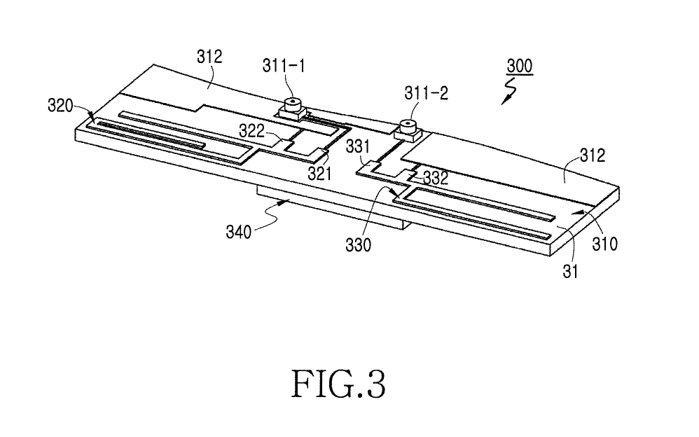

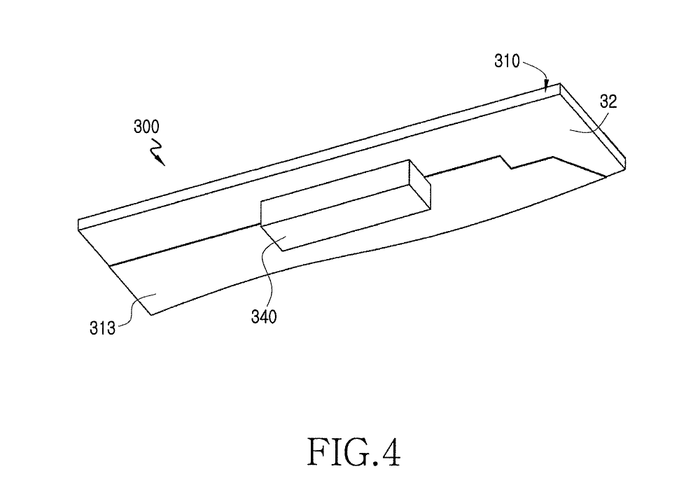

FIGS. 3 and 4 illustrate an antenna apparatus according to an embodiment of the present disclosure.

Referring to FIG. 3, the antenna apparatus 300 includes a main board 310, and first and second antennas 320 and 330 attached to the main board 310. The main board 310 processes signals transmitted or received through the antennas 320 and 330. The main board 310 includes various circuits and components and is configured to set an execution environment of a terminal, retain information, stably drive the terminal, and facilitates input/output of data to be exchanged among all devices of the terminal. The main board 310 includes feeder units 311-1 and 311-2 configured to supply power to the antennas 320 and 330, and a ground layer 312.

The first antenna 320 includes a feeder terminal 321 electrically coupled to the feeder unit 311-1 of the main board 310, and a ground terminal 322 electrically coupled to the ground layer 312 of the main board 310. Likewise, the second antenna 330 includes a feeder terminal 321 electrically coupled to the feeder unit 311-2 of the main board 310, and a ground terminal 312 electrically coupled to the ground layer 312 of the main board 310. The antennas 320 and 330 are supplied with signals from the feeder terminals 311-1 and 311-2.

The first antenna 320 and the second antenna 330 are disposed close to each other on the top surface 31 of the main board 310. In particular, referring to FIG. 4, the antenna apparatus 300 according to the embodiment of the present disclosure further includes a ground body 340 capable of improving isolation between the two adjacent antennas 320 and 330. The ground body 340 is disposed on a bottom surface 32 of the main body 310 at positions facing the antennas 320 and 330; however, the present disclosure is not limited thereto. If a spatial margin exists, the ground body 340 can be disposed on a top surface 31 of the main body 310. The ground body 340 can be electromagnetically coupled to the antennas 320 and 330 and can remove an interference signal between the antennas 320 and 330.

The first antenna 320 and the second antenna 330 of FIG. 3 can be formed during the fabrication of the main board 310 or can be a metal thin film attached to the main board 310 in a post-processing step.

The present disclosure is not limited thereto. For example, the first antenna 320 and the second antenna 330 can be a bent metal plate attached to a carrier that is fixed to the main board 310.

In addition, the present disclosure is not limited to the configuration in which the first antenna 320 and the second antenna 330 are disposed on the top surface of the main board 310. For example, the first antenna 320 and the second antenna 330 can be disposed on different surfaces relative to one another.

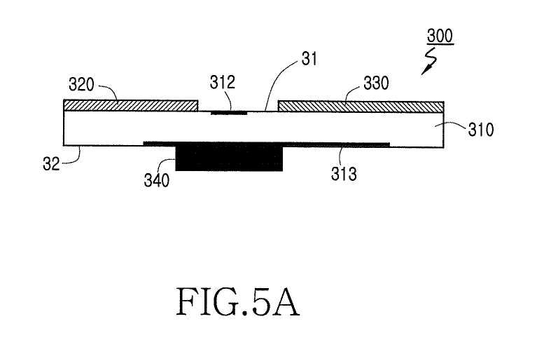

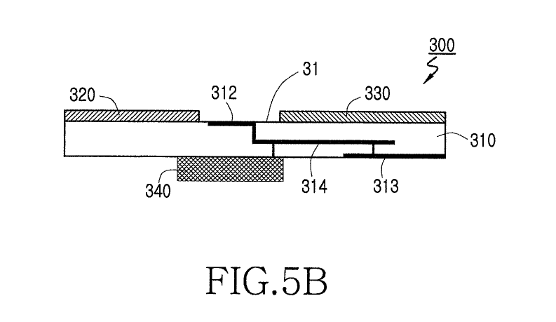

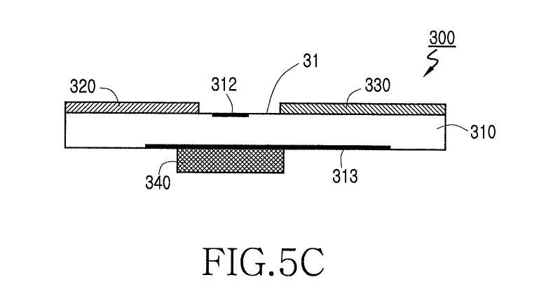

FIGS. 5A to 5C illustrate example configurations of the antenna apparatus according to the embodiment of the present disclosure.

Referring to FIG. 5A, the ground body 340 can be a ground layer of the main board comprising a relatively thick portion as compared to the other portions of the main board.

In addition, referring to FIG. 5B, the ground body 340 can be electrically coupled through a via to a ground layer 312 disposed on a non-ground surface of the bottom surface 32 of the main board 310 or a ground layer 314 disposed inside the main board 310. The present disclosure is not limited thereto. For example, the ground body 340 can be disposed on a non-ground surface of the bottom surface 32 of the main board 310 and be electrically coupled through a line to a ground layer 313 disposed on the bottom surface 32 of the main board 310 or a ground layer 314 disposed inside the main board 310.

In addition, referring to FIG. 5C, the ground body 340 can be electrically attached to the ground layer 313 disposed on the bottom surface 32 of the main board 310.

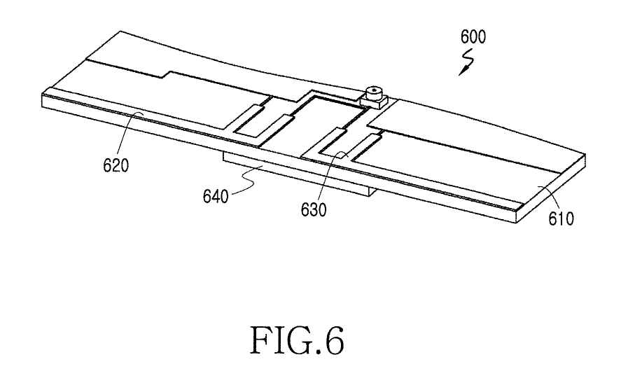

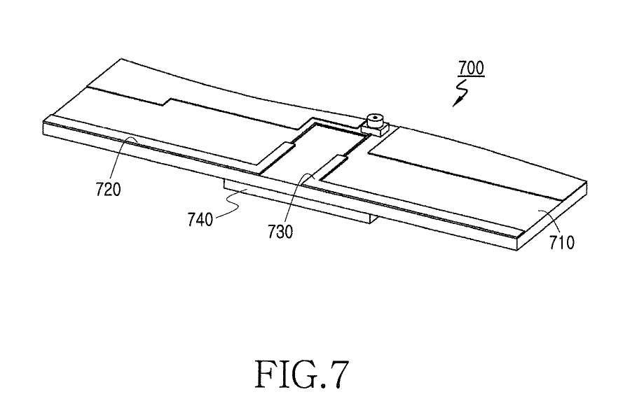

FIGS. 6 and 7 illustrate example antenna apparatuses according to embodiments of the present disclosure.

Referring to FIGS. 6 and 7, an antenna apparatus 600 according to an embodiment of the present disclosure has a configuration similar to that of the antenna apparatus 300 of FIG. 3. However, the antenna apparatus 600 of FIG. 6 includes antennas 620 and 630 having shapes symmetrical with respect to each other. Furthermore, an antenna apparatus 700 of FIG. 7 operates as a known monopole antenna apparatus different from the antenna apparatuses 300 and 600 of FIGS. 3 and 6 which operates as an inverted F antenna (IFA) apparatus.

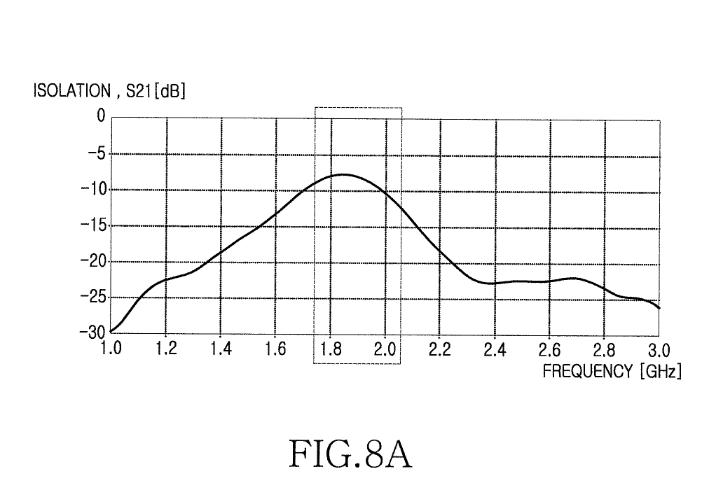

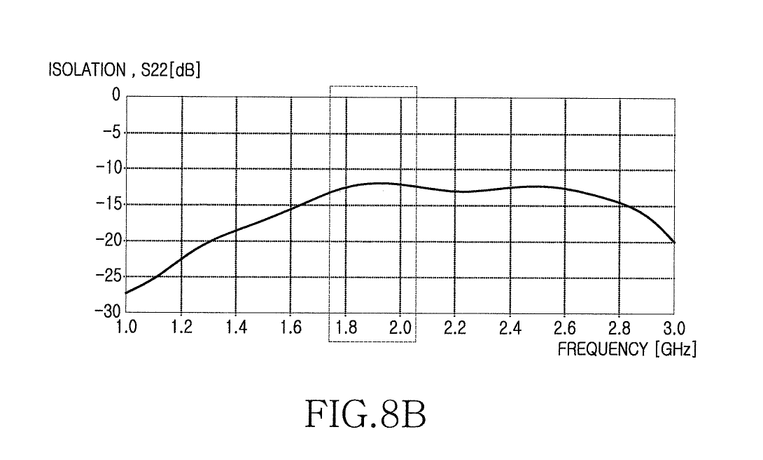

FIG. 8A illustrates an example graph depicting an isolation level S21 of the conventional antenna apparatus, and FIG. 8B illustrates a graph depicting an isolation level S21 of the antenna according to embodiments of the present disclosure.

The conventional antenna apparatus does not include a ground body that protrudes from the main board in order to provide electromagnetic coupling with antennas. Referring to FIGS. 8A and 8B, the antenna apparatus 600 according to the embodiment of the present disclosure shows that isolation is improved in a preset resonance frequency band (e.g., 1.8 GHz to 2.0 GHz) as compared to the conventional antenna apparatus.

Consequently, the antenna apparatus for the portable terminal according to the embodiment of the present disclosure can ensure the performance by reducing mutual interference between adjacent antennas.

While the disclosure has been shown and described with reference to certain preferred embodiments thereof, it will be understood by those skilled in the art that various changes in form and details may be made therein without departing from the spirit and scope of the disclosure as defined by the appended claims. Therefore, the scope of the disclosure is defined not by the detailed description of the disclosure but by the appended claims, and all differences within the scope will be construed as being included in the present disclosure.

What is claimed is:

1. An antenna apparatus configured for use with a portable terminal, the antenna apparatus comprising:
a main board;
a first antenna and a second antenna electrically coupled to the main board and spaced apart from each other on the main board; and
a ground body protruding from a top surface or a bottom surface of the main board.

2. The antenna apparatus of claim 1, wherein the first antenna and the second antenna are disposed on the top surface of the main board, and the ground body is disposed on the bottom surface of the main board and faces the first antenna and the second antenna.

3. The antenna apparatus of claim 1, wherein the first antenna is disposed on the top surface of the main board, and the second antenna is disposed on the bottom surface of the main board.

4. The antenna apparatus of claim 2, wherein the first antenna and the second antenna are disposed on at least one of an upper end and a lower end of the main board.

5. The antenna apparatus of claim 1, wherein the main board comprises a ground layer on at least one of the top surface and the bottom surface of the main board, and the ground body is electrically attached on the ground layer of the main board.

6. The antenna apparatus of claim 1, wherein the ground body is attached to a non-ground surface of the main board and is electrically coupled through a line or a via of the main board.

7. The antenna apparatus of claim 1, wherein the ground body comprises a ground layer of the main board comprising a relatively thicker portion than other portions of the main board.

8. The antenna apparatus of claim 1, wherein the first antenna or the second antenna comprises a metal thin film disposed on the main board.

9. The antenna apparatus of claim 1, wherein at least one of the first antenna and the second antenna comprises a bent metal plate attached to a carrier that is fixed to the main board.

10. The antenna apparatus of claim 1, wherein the first antenna and the second antenna have shapes symmetrical with respect to each other.

11. The antenna apparatus of claim 1, wherein the antenna apparatus comprises at least one of a diversity antenna apparatus and a MIMO antenna apparatus.

12. The antenna apparatus of claim 1, wherein the first antenna and/or the second antenna operate as a monopole antenna.

13. The antenna apparatus of claim 1, wherein at least one of the first antenna and the second antenna are configured to operate as an inverted F antenna (IFA).

14. The antenna apparatus of claim 1, wherein the ground body is configured to remove harmful signals generated due to interference between the first antenna and the second antenna in a preset communication service band.

15. The antenna apparatus of claim 1, wherein the first antenna and the second antenna are configured to transmit and receive signals in a similar communication frequency band.

16. The antenna apparatus of claim 1, wherein the first antenna and the second antenna are configured to transmit and receive signals in different communication frequency bands.

17. A portable terminal including an antenna apparatus, the portable terminal comprising:
a main board;
a first antenna and a second antenna electrically coupled to the main board and spaced apart from each other on the main board; and
a ground body protruding from a top surface or a bottom surface of the main board,
wherein the ground body is configured to remove harmful signals generated due to interference between the first antenna and the second antenna in a preset communication service band.

18. The portable terminal of claim 17, wherein the first antenna is disposed on the top surface of the main board, and the second antenna is disposed on either the top surface or the bottom surface of the main board.

19. The portable terminal of claim 17, wherein the main board comprises a ground layer on at least one of the top surface or the bottom surface of the main board, and the ground body is electrically coupled to the ground layer of the main board.

20. The portable terminal of claim 17, wherein the ground body is attached to a non-ground surface of the main board and is electrically coupled through a line or a via of the main board, and
wherein the ground body comprises a ground layer of the main board comprising a relatively thicker portion than other portions of the main board.
